(19) United States
(12) Patent Application Publication
(10) Pub. No.: US 2022/0205188 A1
(43) Pub. Date: Jun. 30, 2022

(54) FULL-DEPTH ULTRA-THIN LONG-LIFE PAVEMENT STRUCTURE AND CONSTRUCTION METHOD THEREOF

(71) Applicant: SHANDONG PROVINCIAL COMMUNICATIONS PLANNING AND DESIGN INSTITUTE GROUP CO., LTD, Jinan City (CN)

(72) Inventors: Yufeng BI, Jinan City (CN); Min SUN, Jinan City (CN); Wei ZHUANG, Jinan City (CN); Sai CHEN, Jinan City (CN); Hao CHEN, Jinan City (CN); Jian WANG, Jinan City (CN)

(21) Appl. No.: 17/466,464

(22) Filed: Sep. 3, 2021

(30) Foreign Application Priority Data
Dec. 30, 2020 (CN) 202011610548.X

(51) Int. Cl. E01C 7/32; E01C 19/00; C04B 26/16; C04B 26/26; C04B 14/02; C04B 14/34; C04B 14/28; C04B 24/24

(52) U.S. Cl. CPC E01C 7/32; E01C 19/002; C04B 26/16; C04B 26/26; C04B 2111/0075; C04B 14/34; C04B 14/28; C04B 24/243; C04B 14/022

(57) ABSTRACT

A full-depth ultra-thin long-life pavement structure and a construction method thereof are disclosured. The pavement structure is disposed on a subgrade, and the pavement includes from bottom to top: a composite joint layer, a fatigue-resistant layer, a load-bearing layer, a high-strength bonding layer and a skid-resistant wearing layer; the composite joint layer comprises a bottom layer and an upper layer, the bottom layer is a graded gravel layer, and the upper layer is an open-graded large-particle-size water-permeable polyurethane and gravel mixture layer; the fatigue-resistant layer is paved by a skeleton-interlocking structural polyurethane mixture; the load-bearing layer is paved by a suspended-dense typed polyurethane mixture; the high-strength bonding layer is formed by curing a polyurethane-based composite material; the skid-resistant wearing layer is paved by a high-viscosity and high-elasticity modified asphalt mixture.

### CROSS REFERENCE TO RELATED APPLICATION

This patent application claims the benefit and priority of Chinese Patent Application No. 202011610548.X filed on Dec. 30, 2020, the disclosure of which is incorporated by reference herein in its entirety as part of the present application.

### TECHNICAL FIELD

The disclosure relates to a full-depth ultra-thin long-life pavement structure and a construction method thereof, belonging to the technical field of road engineering.

### BACKGROUND ART

The contemporary road technologies are transforming and developing towards the “fifth generation” intelligent roads characterized by durability, greenness and intelligence, among which the research and development of long-life pavement technology is one of the core objectives. The construction of long-life pavement may reduce the excessive life-cycle cost caused by the frequent maintenance, reduce resource waste, and ensure the excellent-good rate of pavement performance and the traffic capacity of road network. The long-life pavement is an effective way to reduce the full-life cost and user cost.

At present, most of long-life pavements adopt the structures of semi-rigid base layer asphalt pavement or full-depth asphalt pavement, mainly extending the service life of the pavement by the following ways: (1) adding admixtures of such as anti-rutting agents or high modulus additives to an asphalt mixture or using a composite modified asphalt and the like to improve the performance of the asphalt mixture; (2) increasing the number of structural layer and the thickness of structural layer to reduce the tensile strain at the bottom of the pavement structural layer.

Chinese patent application CN103669154A discloses a design method for durable bituminous pavement with layer-by-layer progressively-increased structural layer life. The durable bituminous pavement with layer-by-layer progressively-increased structural layer life is composed of a durable surface layer, a long-life base layer and a permanent subgrade, in which the durable surface layer is paved with a high-quality high-performance asphalt mixture with a thickness of 18 cm-36 cm, the long-life base layer is paved with a high-quality inorganic binder stabilized base layer with a thickness of 60 cm-80 cm, the permanent subgrade is an embankment or a road cutting, and the thickness of the entire pavement structure is 78 cm-116 cm.

Chinese patent application CN103243626A discloses a semi-rigid base bituminous pavement durable structure applicable to heavy traffic, including the following structural layers from top to bottom: a 4 cm surface layer of modified SAC asphalt concrete, a modified asphalt waterproof bonding layer, a 6 cm middle layer of heavy SAC asphalt concrete, a 2 cm lower layer of modified SAC asphalt concrete, a modified asphalt waterproof bonding layer, four semi-rigid base layers with a thickness of 20 cm for each and a soil base. The thickness of the entire pavement structural layer is greater than 92 cm.

Chinese patent application CN103321121A discloses a long-service-life asphalt pavement structure based on uniform settlement. The pavement structure includes an asphalt surface layer and a fatigue-resistant cement stabilized gravel base layer from top to bottom, where the asphalt surface layer includes a surface layer, a middle layer and a lower layer from top to bottom, and a tack-coat oil is sprayed between the surface layer and the middle layer and between the middle layer and the lower layer.

Chinese patent application CN107165017A discloses a permanent composite pavement structure for reconstruction of old asphalt pavement, including a high-performance cement concrete layer, an asphalt surface layer, a base layer, a sub-base layer and a subgrade from top to bottom. The high-performance cement concrete layer is arranged on the asphalt surface layer, and the latter is arranged on the base layer. Alternatively, the high-performance cement concrete layer replaces the asphalt surface layer to be arranged on the base layer. The base layer is arranged on the sub-base layer, and the latter is arranged on the subgrade. A vertical recess penetrates through the asphalt surface layer and the base layer (penetrating the base layer only if there is no asphalt surface layer), and a high-performance cement concrete column is filled in the vertical recess and connected to the high-performance cement concrete layer and the sub-base layer, respectively.

The improvement in performance of the asphalt mixture and increase in number and thickness of the pavement structural layer have improved the durability of the asphalt pavement structure to a certain extent, but cannot essentially solve the inherent problems of such asphalt pavement structure, such as the weak fatigue-resistant load capacity, easy shear failure between layers, easy reflection of base layer cracks to surface layer, and easy occurrence of rutting and pothole diseases. Moreover, many new problems are caused. For example, the application of a large amount of asphalt modifiers and asphalt mixture admixtures increases the engineering costs, the application of different types, batches and quality of modifiers leads to difficulties in engineering quality control, and the larger thickness and larger number of the pavement structural layer lead to an increase in the amount of construction materials such as sand, soil, cement and asphalt, which increase the cost and difficulty in construction, and the construction quality cannot be guaranteed.

### SUMMARY

In order to overcome the shortcomings above of the prior art, the present disclosure provides a full-depth ultra-thin long-life pavement structure and a construction method thereof. The method uses a polyurethane material with different mineral aggregates to prepare pavement structural layers having different functions, and synthesizes the full-depth ultra-thin long-life pavement structure according to the functional differences of the pavement structural layers. The pavement structure has good overall stability, high joint strength between layers, strong fatigue-resistant load capacity, small number of structural layers and small thickness of structural layers, which may effectively extend the service life of pavement structures.

A full-depth ultra-thin long-life pavement structure, where the full-depth long-life pavement structure is disposed on a subgrade, and the full-depth long-life pavement includes from bottom to top: a composite joint layer, a fatigue-resistant layer, a load-bearing layer, a high-strength bonding layer and a skid-resistant wearing layer;

the composite joint layer includes a bottom layer and an upper layer, the bottom layer is a graded gravel layer, and the upper layer is an open-graded large-particle-size water-permeable polyurethane and gravel mixture layer;

the fatigue-resistant layer is paved by a skeleton-interlocking structural polyurethane mixture;

the load-bearing layer is paved by a suspended-dense typed polyurethane mixture;

the high-strength bonding layer is formed by curing a polyurethane-based composite material;

the skid-resistant wearing layer is paved by a high-viscosity and high-elasticity modified asphalt mixture.

In some embodiments, a thickness of the graded gravel layer is in a range of 6-15 cm; a thickness of the open-graded large-particle-size water-permeable polyurethane and gravel mixture layer is in a range of 8-12 cm; a thickness of the fatigue-resistant layer is in a range of 5-9 cm; a thickness of the load-bearing layer is in a range of 6-12 cm; a thickness of the high-strength bonding layer is in a range of 1-3 mm; a thickness of the skid-resistant wearing layer is in a range of 3-6 cm.

In some embodiments, the graded gravel layer is prepared by mixing aggregates with diameters of 0-5 mm, 5-10 mm, 10-20 mm and 20-30 mm according to a mass ratio of (25-35):(20-30):(40-50):(0.1-10).

In some embodiments, the open-graded large-particle-size water-permeable polyurethane and gravel mixture layer is a skeleton-pore structure mixture with a porosity of 15%-20% prepared by mixing a mineral aggregate and a polyurethane binder according to a mass ratio of (95-98):(2-5); the mineral aggregate is prepared by mixing aggregates with diameters of 0-3 mm, 3-5 mm, 5-10 mm, 10-20 mm and 20-30 mm according to a mass ratio of (25-35):(20-30):(20-40):(0.1-15):(0.1-15).

In some embodiments, the skeleton-interlocking structural polyurethane mixture is a mixture with a porosity of 13%-18% prepared by mixing a polyurethane binder and a mineral aggregate according to a mass ratio of (94-97):(3-6); the mineral aggregate is prepared by mixing a mineral powder and aggregates with diameters of 0-3 mm, 3-5 mm, 5-10 mm and 10-20 mm according to a mass ratio of (0.1-5):(0.1-10):(5-20):(25-50):(10-30).

In some embodiments, the suspended-dense typed polyurethane mixture is a mixture with a porosity of 2%-5% prepared by mixing a mineral aggregate, a rubber powder and a polyurethane binder according to a mass ratio of (92-95):(0-10):(3-6); the mineral aggregate is prepared by mixing a mineral powder and aggregates with diameters of 0-3 mm, 3-5 mm, 5-10 mm and 10-20 mm according to a mass ratio of (3-10):(30-40):(10-20):(10-30):(10-20).

In some embodiments, the polyurethane-based composite material is prepared by mixing a polyurethane binder, a filler, an additive and an anti-stripping agent according to a mass ratio of (56-85):(32-50):(5-12):(0.1-1); the filler is a light calcium powder; the additive is carbon black; the anti-stripping agent is a hydroxyl-terminated phosphorus-containing polyester.

In some embodiments, the high-viscosity and high-elasticity modified asphalt mixture is prepared by mixing an aggregate, a mineral powder and a high-viscosity and high-elasticity modified asphalt according to a mass ratio of (85-95):(5-10):(3-6), with a porosity of 3-5%.

In some embodiments, the high-viscosity and high-elasticity modified asphalt is one selected from the group consisting of a SBS composite modified asphalt, a polyurethane composite modified asphalt and a rubber powder composite modified asphalt.

In some embodiments, the aggregate is one selected from the group consisting of basalt and diabase; the mineral powder is a limestone powder.

In some embodiments, the polyurethane binder is a one-component moisture-curing binder prepared according to the method disclosed in CN109180071B; the aggregate is one selected from the group consisting of basalt and diabase; the mineral powder is a limestone powder.

A construction method of the full-depth ultra-thin long-life pavement structure, including:

1) mixing the graded gravel with an on-site mixing method, where a stabilized soil mixer is used to mix for 2-4 times to obtain a mixture, and when a water content of the mixture is equal to or slightly greater than an optimal water content, a vibratory roller of 12 t or more is immediately used to roll the mixture from both sides to middle until a specified degree of compaction is reached;

2) producing mixtures for the open-graded large-particle-size water-permeable polyurethane and gravel mixture layer, the fatigue-resistant layer and the load-bearing layer by a batching asphalt mixing station, where materials are not required to be heated during construction, transported with a dump truck to a construction site, paved with an asphalt mixture paver at a speed of 1.5-2.0 m/min, and subjected to a static press with a steel wheel roller for 2-4 times at a speed of 2.5-3.5 km/h; for each layer, after compaction for 24-36 h, a next layer is constructed;

3) distributing the polyurethane composite material with a distributor for the high-strength bonding layer, with a distributing amount in a range of 1-3 kg/m²;

4) preparing the skid-resistant wearing layer by using the same construction method as that of a conventional hot-mixing modified asphalt mixture, to achieve the construction of the full-depth ultra-thin long-life pavement structure.

The composite joint layer is composed by using a graded gravel layer and an open-graded large-particle-size water-permeable polyurethane and gravel mixture layer, which act as a whole and form a flexible joint layer structure together. Firstly, the composite joint layer may release the stress on the top surface of the soil base, bear the upper load and transfer it to the soil base, and effectively inhibit the crack reflection and improve the temperature and humidity state of the materials in upper and lower layers. Secondly, the open-graded large-particle-size water-permeable polyurethane and gravel mixture layer forms a single-particle-size interlocking skeleton, and a small amount of fine aggregates is used for filling to improve the modulus and durability of the mixture, such that both good drainage performance and high modulus and durability are achieved. The graded gravel layer and the open-graded large-particle-size water-permeable polyurethane and gravel mixture layer may lead the free water entering the pavement structure to the subgrade and the road shoulder structures on both sides so as to gradually drain it, ensuring the water stability of the whole pavement structure. Thirdly, the composite joint layer forms a full-depth structure with the fatigue-resistant layer and the load-bearing layer together, which improves the structural bearing capacity and fatigue-resistant performance, realizing a desirable transition between the subgrade and pavement.

In the fatigue-resistant layer, the optimization theory of aggregate interlocking structure is used for the mineral aggregate grading design of the skeleton-interlocking structural polyurethane mixture. The skeleton-interlocking structural polyurethane mixture has excellent fatigue-resistant properties and high strength, and acts as a whole with the load-bearing layer while meeting the requirements of the fatigue-resistant layer to improve the bearing capacity of the whole structure.

The load-bearing layer is formed through paving and compacting the polyurethane mixture prepared by mixing a polyurethane binder, a coarse aggregate, a fine aggregate, a rubber powder and a limestone powder at normal temperature. Continuous grading is used for the grading design of the mineral aggregate. The polyurethane mixture has a suspended and dense structure with a small porosity, which reduces water entering the pavement structure from top to bottom, and also has high splitting strength and strong ability to withstand bending and tensile stress.

The high-strength bonding layer is formed after the polyurethane-based composite material is evenly distributed on the surface of the load-bearing layer and then cured. On the one hand, the macromolecular chain segments in the polyurethane binder interact with the surface of the inorganic CaCO₃ in the filler; on the other hand, the polyurethane macromolecular chain itself will also cause interweaving effect. Due to the above two aspects of effect, filler particles are completely wrapped and wound inside the binder, thereby increasing the tensile strength of the binder to a certain extent. Carbon black may improve the physical state of the polyurethane binder to meet the requirements of the construction operation on the one hand, and may absorb CO₂ released during curing on the other hand. The hydroxyl-terminated phosphorus-containing polyester may not only react with the excess isocyanate groups in the polyurethane binder, but also form chemical adsorption with stones in the skid-resistant wearing layer and the load-bearing layer, thereby improving the bonding performance between the two layers.

The respective structural layers act synergistically and realize the effects of the pavement structure together. The skid-resistant wearing layer contains the high-viscosity and high-elasticity modified asphalt mixture forming a skeleton dense structure, which provides a good driving surface for vehicles, may be directly overlaid, milled or regenerated, is easy to maintain, and does not affect the strength and bearing capacity of the pavement structure. The load-bearing layer of polyurethane mixture with a higher modulus is disposed in the high stress zone at 100-150 mm below the surface layer, which may effectively resist the load effect and ensure the stability of the pavement structure. The skeleton-interlocking structural polyurethane mixture is disposed at the bottom of the pavement structural layer, which has a limit for fatigue strain of about 300με and excellent fatigue resistance, thereby resisting the tensile strain at the bottom of structural layer, controlling the bottom-up fatigue cracking, and effectively ensuring the service life of the entire pavement structure. The same type of binders are used between the composite joint layer and the fatigue-resistant layer and between the fatigue-resistant layer and the load-bearing layer, and the high-strength bonding layer composed of the polyurethane composite material is used between the load-bearing layer and the skid-resistant wearing layer, thereby forming a desirable jointing between the structural layers. The composite interlaminar shear test shows that the interlaminar shear strength for each two layers is greater than 0.8 MPa, which may resist the horizontal shear stress between the structural layers, ensuring the integrity of the pavement structure.

The present disclosure has the following beneficial effects:

(1) The pavement structure has good overall stability, high joint strength between layers, strong fatigue-resistant load capacity, small number of structural layers, small thickness of structural layers and obvious synergistic effect between structural layers, which may effectively extend the service life of pavement structures, and solve the problems such as the shortage in sand material in the construction market, poor overall stability of the pavement structure, strong sensitivity to the temperature and humidity, and high construction energy consumption and emission.

(2) The materials in various structural layers of the pavement structure give full play to their respective performance advantages, and act synergistically to ensure the fatigue resistance of the entire pavement structure while reducing the engineering cost. A good jointing between the various structural layers and a good integrity of the entire pavement structure are achieved.

(3) The pavement structure may effectively reduce the thickness of structural layers and the number of structure layers in the long-life pavement. Compared with the currently commonly used combined long-life asphalt pavement with a thickness of 80-90 cm and full-depth long-life asphalt pavement with a thickness of 40-50 cm, the thickness of structural layers in the present disclosure is reduced by 50 cm and 10 cm, respectively, saving a lot of building material resources such as sand, asphalt, cement and soil. Compared with the currently commonly used long-life asphalt pavement with 7-9 layers, only 5 layers are required in the structure recommended by the present disclosure, and each layer is constructed with conventional pavement construction machinery, which reduces the difficulty in construction and effectively guarantees the quality of construction.

### BRIEF DESCRIPTION OF THE DRAWINGS

FIG. 1 shows a schematic diagram of a full-depth ultra-thin long-life pavement structure.

### DETAILED DESCRIPTION OF THE EMBODIMENTS

In order for a better understanding of those skilled in the art to the technical solutions in the present disclosure, the disclosure will be described in detail below with reference to embodiments. The embodiments described are only parts of, rather than all of, the embodiments in the disclosure, and the present disclosure is not limited by the embodiments described below.

The “Outline for Building a Country with Strong Transportation Network” clearly states to “promote conserving and intensive utilization of resource” and “strengthen energy saving, emission reduction and pollution prevention”. The disclosure proposes a low-carbon and environmentally friendly full-depth ultra-thin long-life pavement structure, which has good integrity and durability, and may effectively reduce the number of maintenance, save investment and improve the level of road service. Moreover, the pavement structure has relatively thin structural layers, which may save a large amount of road construction materials and reduce energy consumption and emission, making contribution to the high-quality and green development of road construction.

### Example 1 Preparation of the Full-Depth Ultra-Thin Long-Life Pavement Structure

1. Pavement Structure Composition

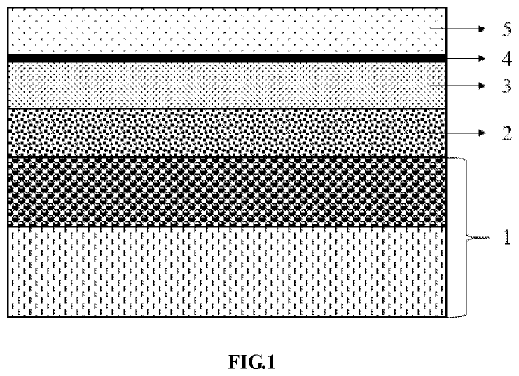

As shown in FIG. 1, the full-depth ultra-thin long-life pavement structure in Example 1 was formed by paving a composite joint layer 1, a fatigue-resistant layer 2, a load-bearing layer 3, a high-strength bonding layer 4 and a skid-resistant wearing layer 5 on the top surface of a subgrade from bottom to top. The composite joint layer was composed of a graded gravel layer and an open-graded large-particle-size water-permeable polyurethane and gravel mixture layer from bottom to top. The technical indicators of the graded gravel layer are shown in Table 1. The open-graded large-particle-size water-permeable polyurethane and gravel mixture layer was a skeleton-pore structure mixture with a porosity of 15%-20% prepared by mixing a mineral aggregate and a polyurethane binder in proportion. The mineral aggregate was prepared by mixing limestone aggregates with diameters of 0-3 mm, 3-5 mm, 5-10 mm, 10-20 mm and 20-30 mm. The mixture type and mineral aggregate grading are shown in Table 2.

The fatigue-resistant layer was prepared by a skeleton-interlocking structural polyurethane mixture, which was prepared by mixing a polyurethane binder and a mineral aggregate. The mineral aggregate was a limestone powder and limestone aggregates with diameters of 0-3 mm, 3-5 mm, 5-10 mm and 10-20 mm. In the case that the optimization theory of aggregate interlocking was used to design the mineral aggregate grading, the influence of interference on the porosity of the mineral aggregate might be eliminated, thereby making the mixture finally form a single-discontinuous or a double-discontinuous grading skeleton-interlocking structure. The mixture designed by this method had the advantages such as large density, high stiffness modulus and good fatigue resistance, which might effectively reduce the amount of the binder. The mixture type and mineral aggregate grading are shown in Table 2.

The load-bearing layer was prepared by a suspended-dense structural polyurethane and rubber powder mixture, which was prepared by mixing a mineral aggregate, a rubber powder and a polyurethane binder. A 40 mesh rubber powder was used. A mass ratio of the rubber powder to the polyurethane binder was 22:78. The mixture type, mineral aggregate grading and binder amount are shown in Table 2.

The skid-resistant wearing layer was paved by a high-viscosity and high-elasticity modified asphalt mixture. The high-viscosity and high-elasticity modified asphalt mixture was prepared by mixing an aggregate, a mineral powder and a high-viscosity and high-elasticity modified asphalt, in which the high-viscosity and high-elasticity modified asphalt was prepared by mixing 5% of polyurethane, 6% of SBS, 2% of a viscosity modifier, 0.8% of a compatilizer and 86.2% of a matrix asphalt in mass percentage. The high-viscosity and high-elasticity modified asphalt had a needle penetration of 42 (0.1 mm), a softening point of 88° C., and a Brookfield viscosity at 135° C. of 2.8 Pa·s. The mixture type, mineral aggregate grading and binder amount are shown in Table 2.

The polyurethane-based composite material was composed of a polyurethane binder, a light calcium carbonate, carbon black and a hydroxyl-terminated phosphorus-containing polyester. A mass ratio of these materials was 75:17:7:1. The mixture type and mineral aggregate grading of each structural layer are shown in Table 2. The technical indicators of mixtures in each structural layer are shown in Table 3.

TABLE 1
Grading range of graded gravel

| Cumulative passing percentage of each sieve (square-hole sieve, mm)/% | | | | | | | Liquid | Plasticity |
|---|---|---|---|---|---|---|---|---|
| 31.5 | 19 | 9.5 | 4.75 | 2.36 | 0.6 | 0.075 | limit/% | index |
| 100 | 95.4 | 68.7 | 48.5 | 29.3 | 14.8 | 5.6 | 17 | 5 |

TABLE 2
Mixtures and grading ranges of mineral aggregates

| | | | | | | | | | | | | | | Binder |
|---|---|---|---|---|---|---|---|---|---|---|---|---|---|---|
| Type of material in | Cumulative passing percentage of each sieve (mm)/% | | | | | | | | | | | | | amount |
| structural layer | 31.5 | 26.5 | 19 | 16 | 13.2 | 9.5 | 4.75 | 2.36 | 1.18 | 0.6 | 0.3 | 0.15 | 0.075 | /% |
| Macropore | 100 | 93.5 | 74.6 | 65.7 | 50.8 | 34.9 | 20.5 | 15.7 | 12.9 | 9.6 | 6.5 | 4.6 | 2.5 | 2.8 |
| polyurethane gravel | | | | | | | | | | | | | | |
| (PPM-25) | | | | | | | | | | | | | | |
| Skeleton-interlocking | 100 | 100 | 100 | 100 | 95.9 | 67.8 | 31 | 21.4 | 16.7 | 11.5 | 8.6 | 6.1 | 2.4 | 4 |
| polyurethane mixture | | | | | | | | | | | | | | |
| (PUM-13) | | | | | | | | | | | | | | |
| Suspended-dense | 100 | 100 | 97.9 | 86.6 | 73.4 | 67.1 | 48.1 | 35.9 | 28.5 | 20.5 | 14.9 | 10.7 | 5.7 | 4.3 |
| typed polyurethane | | | | | | | | | | | | | | |
| mixture (CPUM-13) | | | | | | | | | | | | | | |
| High-viscosity and | 100 | 100 | 100 | 100 | 81.8 | 61.2 | 24.2 | 19.9 | 16.8 | 14.5 | 12.4 | 10.9 | 10.1 | 5.9 |
| high-elasticity | | | | | | | | | | | | | | |
| modified asphalt | | | | | | | | | | | | | | |
| mixture (SMA-13) | | | | | | | | | | | | | | |

TABLE 3
Technical indicators of mixtures

| | | Mineral | | | Dynamic | Dynamic |
|---|---|---|---|---|---|---|
| Type of material | | aggregate | | Marshall | stability/ | modulus at |
| in structural layer | Porosity/% | gap rate/% | Saturability/% | stability/KN | (time/mm) | 20° C./MPa |
| PPM-25 | 19.5 | — | — | 40.8 | 23000 | 14300 |
| PUM-13 | 19.6 | — | — | 47.3 | 53000 | 21800 |
| CPUM-13 | 4.6 | — | — | 48.7 | 48000 | 17700 |
| SMA-13 | 3.8 | 23 | 83.5 | 15.4 | 14000 | 14200 |

2. Construction Method

For the graded gravel layer, a stabilized soil mixer was used to mix for 2-4 times to obtain a mixture. A vibratory roller of 20 t was used to roll the mixture from both sides to middle until the degree of compaction was greater than or equal to 95%.

For the open-graded large-particle-size water-permeable polyurethane and gravel mixture layer, the fatigue-resistant layer and the load-bearing layer, the mixtures for the layers were produced by a batching asphalt mixing station. The raw materials were not required to be heated during construction. They were transported with a dump truck to a construction site. An asphalt mixture paver was used for paving at a speed of 1.5 m/min, and a steel wheel roller was used for static press for 3 times at a speed of 2.5 km/h. For each layer, after compaction for 24 h, a next layer is constructed.

For the high-strength bonding layer, a distributor was used to distribute the polyurethane composite material, with a distributing amount of 1 kg/m².

For the skid-resistant wearing layer, the same construction method as that of a conventional hot-mixing modified asphalt mixture was used. Thus, the full-depth ultra-thin long-life pavement structure was achieved, as shown in FIG. 1.

3. Test Results

(1) The inclined shear test was used to test the interlaminar shear strength between the skid-resistant wearing layer and the load-bearing layer under different environmental conditions.

The test results are shown in Table 4.

TABLE 4
Interlaminar shear strength under
different environmental conditions

| Test condition | Shear strength/MPa |
|---|---|
| Normal temperature | 2.53 |
| 60° C. | 1.73 |
| After freeze-thaw cycle | 1.58 |

By analyzing the data in Table 4, it may be seen that the interlaminar shear strength results under different test conditions are all greater than 1 MPa, indicating that the pavement structure has a good jointing at the interface between structural layers and a good integrity.

(2) The four-point bending fatigue test was used to test the fatigue life of the fatigue-resistant layer under different strain levels. The results are shown in Table 5.

TABLE 5
Fatigue life of fatigue-resistant layer under different strain levels

| Strain level/με | Fatigue life/time |
|---|---|
| 600 | 734700 |
| 700 | 428900 |
| 800 | 364220 |
| 1000 | 192980 |

Based on the extrapolation method, in accordance with the test data in Table 5, the fatigue performance equation (1) proposed by Carpenter S H et al. was used to calculate the fatigue limit of the mixture in the fatigue-resistant layer, which was 295με, and the fatigue life prediction equation (2) for the mixture in the fatigue-resistant layer was established. The fatigue limit of the modified asphalt mixture was about 100με, while the fatigue limit of the fatigue-resistant layer in the skeleton-interlocking structural polyurethane mixture was about 3 times that of the modified asphalt mixture, indicating that the fatigue-resistant layer had a strong ability to resist the repeated action of the traffic load.

LgN_{f}=A−BLg(ε−εᵣ) (1)

where εᵣ is the fatigue limit of the mixture, and N_{f} is the fatigue life of the mixture.

LgN_{f}=9.686−1.5408Lg(ε−295) (2)

The pavement structure makes full use of the properties of the polyurethane mixture such as the excellent fatigue resistance, rutting resistance, energy saving and environmental protection to reduce the thickness of the long-life pavement, and to have good integrity and strong ability to resist the repeated actions of the traffic load. Also, the pavement structure is convenient for maintenance, saves energy and reduces emission, and is beneficial to environmental protection, providing a new type of structure and form for the long-life pavement construction.

### Example 2 Comparison of the Full-Depth Ultra-Thin Long-Life Pavement Structure

1. Advantage on Composition of Pavement Structure

The typical full-depth long-life asphalt pavement and combined long-life asphalt pavement were selected for comparative analysis. The pavement structures are shown in Table 6. The total thickness of the full-depth ultra-thin long-life pavement is only 81.0% of the structure II and 41.5% of the structure III, which significantly reduces the thickness of the long-life pavement.

TABLE 6
Pavement structures and thickness

| | Pavement structure composition | Total thickness/cm |
|---|---|---|
| Full-depth ultra-thin | 4 cm of SMA-13 + bonding layer + 6 cm of CPUM-13 + 8 cm | 34 cm |
| long-life pavement | of PUM-13 + 6 cm of PPM-25 + 10 cm of graded gravel | |
| (structure I) | | |
| Full-depth long-life | 4 cm of SMA-13 + 10 cm of EME-16 + 11 cm of | 42 cm |
| asphalt pavement | EME-20 + 10 cm of LSPM-25 + 7 cm of AC-13F | |
| (structure II) | | |
| Combined long-life | 4 cm of SMA-13 + 6 cm of AC-20 + 8 cm of AC-25 + 10 cm | 82 cm |
| asphalt pavement | of LSPM-25 + 18 cm of cement stabilized gravel + 18 cm of | |
| (structure III) | cement stabilized gravel + 18 cm of cement stabilized gravel | |

2. Advantage on Cost of Pavement Structure

An expressway with a length of 1 km and a pavement width of 25 m was taken as an example. According to the current market prices of materials, the amount and cost of various materials for the three pavement structures as formulated in Table 6 were calculated, and the calculation results are shown in Table 7.

TABLE 7
Amount and cost of materials for three pavement structures

| | | | Fatigue life of | Minimum of | | Natural gas |
|---|---|---|---|---|---|---|
| | Material | Total | fatigue-resistant | interlaminar | | consumption |
| | cost/ten-thousand | amount of | layer at 800 | shear | CO₂ | during material |
| | yuan | mixture/t | με/time | strength/MPa | emission/kg | production/m³ |
| Structure I | 976.46 | 22250 | 364220 | 1.47 | 38335.3 | 19518.9 |
| Structure II | 943.74 | 26250 | 109950 | 0.95 | 392936.3 | 200069.4 |
| Structure III | 1198.75 | 51250 | 62500 | 0.48 | 249179.0 | 126873.2 |

By analyzing the data in Table 7, it may be seen that compared with the conventional long-life pavement structure, the ultra-thin long-life pavement has excellent fatigue-resistant performance and good integrity of pavement structure. The ultra-thin long-life pavement greatly reduces the thickness of the pavement structure. Compared with structure II and structure III, the amount of mixture is decreased by 15.2% and 56.6%, respectively. The material cost is increased by 3.5% compared to structure II, and is decreased by 8.1% compared to structure III. Moreover, since the polyurethane mixture in the ultra-thin long-life pavement is constructed at normal temperature, the CO₂ emission and the natural gas consumption are reduced by 90.2% and 84.6%, respectively, compared with structure II and structure III. In conclusion, the recommended full-depth ultra-thin long-life pavement structure has significant economic and environmental benefits and is valuable for promotion and application.

What is claimed is:

1. A full-depth ultra-thin long-life pavement structure, wherein the full-depth long-life pavement structure is disposed on a subgrade, and the full-depth long-life pavement comprises from bottom to top: a composite joint layer, a fatigue-resistant layer, a load-bearing layer, a high-strength bonding layer and a skid-resistant wearing layer;
the composite joint layer comprises a bottom layer and an upper layer, the bottom layer is a graded gravel layer, and the upper layer is an open-graded large-particle-size water-permeable polyurethane and gravel mixture layer;
the fatigue-resistant layer is paved by a skeleton-interlocking structural polyurethane mixture;
the load-bearing layer is paved by a suspended-dense typed polyurethane mixture;
the high-strength bonding layer is formed by curing a polyurethane-based composite material;
the skid-resistant wearing layer is paved by a high-viscosity and high-elasticity modified asphalt mixture.

2. The pavement structure of claim 1, wherein a thickness of the graded gravel layer is in a range of 6-15 cm; a thickness of the open-graded large-particle-size water-permeable polyurethane and gravel mixture layer is in a range of 8-12 cm; a thickness of the fatigue-resistant layer is in a range of 5-9 cm; a thickness of the load-bearing layer is in a range of 6-12 cm; a thickness of the high-strength bonding layer is in a range of 1-3 mm; a thickness of the skid-resistant wearing layer is in a range of 3-6 cm.

3. The pavement structure of claim 1, wherein the graded gravel layer is prepared by mixing aggregates with diameters of 0-5 mm, 5-10 mm, 10-20 mm and 20-30 mm according to a mass ratio of (25-35):(20-30):(40-50):(0.1-10).

4. The pavement structure of claim 1, wherein the open-graded large-particle-size water-permeable polyurethane and gravel mixture layer is a skeleton-pore structure mixture with a porosity of 15%-20% prepared by mixing a mineral aggregate and a polyurethane binder according to a mass ratio of (95-98):(2-5); the mineral aggregate is prepared by mixing aggregates with diameters of 0-3 mm, 3-5 mm, 5-10 mm, 10-20 mm and 20-30 mm according to a mass ratio of (25-35):(20-30): 20-40):(0.1-15):(0.1-15).

5. The pavement structure of claim 1, wherein the skeleton-interlocking structural polyurethane mixture is a mixture with a porosity of 13%-18% prepared by mixing a polyurethane binder and a mineral aggregate according to a mass ratio of (94-97):(3-6); the mineral aggregate is prepared by mixing a mineral powder and aggregates with diameters of 0-3 mm, 3-5 mm, 5-10 mm and 10-20 mm according to a mass ratio of (0.1-5):(0.1-10):(5-20):(25-50):(10-30).

6. The pavement structure of claim 1, wherein the suspended-dense typed polyurethane mixture is a mixture with a porosity of 2%-5% prepared by mixing a mineral aggregate, a rubber powder and a polyurethane binder according to a mass ratio of (92-95):(0-10):(3-6); the mineral aggregate is prepared by mixing a mineral powder and aggregates with diameters of 0-3 mm, 3-5 mm, 5-10 mm and 10-20 mm according to a mass ratio of (3-10):(30-40):(10-20):(10-30):(10-20).

7. The pavement structure of claim 1, wherein the polyurethane-based composite material is prepared by mixing a polyurethane binder, a filler, an additive and an anti-stripping agent according to a mass ratio of (56-85):(32-50):(5-12):(0.1-1); the filler is a light calcium powder; the additive is carbon black; the anti-stripping agent is a hydroxyl-terminated phosphorus-containing polyester.

8. The pavement structure of claim 1, wherein the high-viscosity and high-elasticity modified asphalt mixture is prepared by mixing an aggregate, a mineral powder and a high-viscosity and high-elasticity modified asphalt according to a mass ratio of (85-95):(5-10):(3-6), with a porosity of 3-5%;
the high-viscosity and high-elasticity modified asphalt is one selected from the group consisting of a SBS composite modified asphalt, a polyurethane composite modified asphalt and a rubber powder composite modified asphalt;
the mineral powder is a limestone powder; the aggregate is one selected from the group consisting of basalt and diabase.

9. The pavement structure of claim 3, wherein the aggregate is one selected from the group consisting of basalt and diabase; the mineral powder is a limestone powder.

10. A construction method of the full-depth ultra-thin long-life pavement structure of claim 1, comprising:
1) mixing the graded gravel with an on-site mixing method, wherein a stabilized soil mixer is used to mix for 2-4 times to obtain a mixture, and when a water content of the mixture is equal to or slightly greater than an optimal water content, a vibratory roller of 12 t or more is immediately used to roll the mixture from both sides to middle until a specified degree of compaction is reached;
2) producing mixtures for the open-graded large-particle-size water-permeable polyurethane and gravel mixture layer, the fatigue-resistant layer and the load-bearing layer by a batching asphalt mixing station, wherein materials are not required to be heated during construction, transported with a dump truck to a construction site, paved with an asphalt mixture paver at a speed of 1.5-2.0 m/min, and subjected to a static press with a steel wheel roller for 2-4 times at a speed of 2.5-3.5 km/h; for each layer, after compaction for 24-36 h, a next layer is constructed;
3) distributing the polyurethane composite material with a distributor for the high-strength bonding layer, with a distributing amount in a range of 1-3 kg/m²;
4) preparing the skid-resistant wearing layer by using the same construction method as that of a conventional hot-mixing modified asphalt mixture, to achieve the construction of the full-depth ultra-thin long-life pavement structure.

11. The pavement structure of claim 4, wherein the aggregate is one selected from the group consisting of basalt and diabase; the mineral powder is a limestone powder.

12. The pavement structure of claim 5, wherein the aggregate is one selected from the group consisting of basalt and diabase; the mineral powder is a limestone powder.

13. The pavement structure of claim 6, wherein the aggregate is one selected from the group consisting of basalt and diabase; the mineral powder is a limestone powder.
